(19) United States
(12) Patent Application Publication
(10) Pub. No.: US 2025/0127193 A1
(43) Pub. Date: Apr. 24, 2025

(54) FRY OIL FILTRATION PROVISIONS FOR FOOD PROCESS LINE FRYERS

(71) Applicants: Ryan D. Nothum, Springfield, MO (US); Rex R. Gurnee, JR., Pierce City, MO (US)

(72) Inventors: Ryan D. Nothum, Springfield, MO (US); Rex R. Gurnee, JR., Pierce City, MO (US)

(21) Appl. No.: 18/925,574

(22) Filed: Oct. 24, 2024

Related U.S. Application Data
(60) Provisional application No. 63/592,708, filed on Oct. 24, 2023.

(51) Int. Cl. A23L 5/10

(52) U.S. Cl. CPC A23L 5/11

(57) ABSTRACT

Fry oil filtration starts with a perforated table top covered by filtration media. A hood is lowered onto the media and table to form a pressure-tight compartment. Hot fry oil that carries crumb contaminant material is pumped into the compartment, and which passes through perforations is returned to the fryer. After a RUN time, pumping is discontinued, the hood is raised, and the media with crumb contaminate material caked thereon is moved off the table top. Provide fresh filtration media and start over. Preferably the filtration media is provided in bulk rolls mounted on a roller aside of the table, and courses flat across the table top to a take up roller. Thus, the step of moving the filtration media is by reeling the filtration media onto the take up roller. Crumb contaminate material to crack up and fall away. And fresh filtration media now covers the table top.

### CROSS-REFERENCE TO PROVISIONAL APPLICATION(S)

This application claims the benefit of U.S. Provisional Application No. 63/592,708, filed Oct. 24, 2023. The foregoing patent disclosure is incorporated herein by this reference thereto.

### BACKGROUND AND SUMMARY OF THE INVENTION

The invention generally relates to fryers for automatic and/or mechanized food-process lines and, more particularly, to fry oil filtration provisions therefor.

Exemplary food process line fryers include without limitation the following patent disclosures, which are incorporated herein by this reference thereto.

U.S. Pat. No. 6,305,274—Nothum et al., entitled “Fryer for Food Process Lines;” and

U.S. Pat. No. 9,642,493—Nothum, Jr., entitled “Fryer Cabinet Thermal Oil Heat Exchange.”

It is an object of the invention to filter out loose coating material floating atop or entrained in the fry oil bath before the loose coating material burns and gives off bitter-flavors to the fry oil.

FIG. 1 shows an exemplary automatic and/or mechanized food-process line 50. In such food process lines 50, an infeed of raw meat food-product pieces like chicken tenders is processed through a series of process machines.

In FIG. 1, an initial loader machine 52 loads a stream of food-product pieces onto a transfer conveyor 54, which conveys and discharges the food-product pieces into a first dry-coating machine 56 which pre-dusts the food-product pieces with spices and flour or the like, which discharges into a drum tumbler 58, which discharges into a wet-coating machine 62 which wet coats the pre-dusted food-product pieces with batter or the like, which discharges into a second dry-coating machine 64 which coats the battered food-product pieces with a crumb coating or the like, and then the food-product pieces are fed into a hot-oil fryer 66 (see also FIG. 2) which either partially or fully cooks the food-product pieces, but at least sets the coatings.

Ultimately, the food-product pieces will be typically be furthermore packaged and frozen.

In the fryer 66, it would be ideal if all the coating material on the food-product pieces remained perfectly adhered to the product pieces, and did not drift off by one speck.

But that is not what's typical. A small fraction of crumb/coating material does loosen off and drift away in the fry oil bath. If left there, the crumb/coating material will burn and give off bitter-flavors to the fry oil, or otherwise degrade the fry oil.

So again, it is an object of the invention to filter out contaminate material floating or entrained in the fry oil before it burns and gives off harsh, distasteful flavors to the fry oil.

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a perspective view of an automated and/or mechanized food process line which is to be provided with a fry oil filtration provision in accordance with the invention, wherein food-product pieces are originally loaded onto the conveyor path at the far right and flow through this automated and/or mechanized food process line from right to left;

FIG. 2 is an enlarged-scale perspective view of detail 2-2 in FIG. 1;

FIG. 3 is an enlarged-scale perspective view of detail 3-3 in FIG. 2;

FIG. 4 is a perspective view of the fry oil filtration machine in accordance with the invention, shown in isolation, with a hood which is retractable between SHUT and LIFTED states, shown in the SHUT state;

FIG. 5 is an enlarged-scale section view taken along line 5-5 in FIG. 4, again with the hood shown in the SHUT state; and

FIG. 6 is an enlarged-scale perspective view of detail 6-6 in FIG. 4, except here the hood is shown in a LIFTED state.

### DETAILED DESCRIPTION OF THE PREFERRED EMBODIMENTS

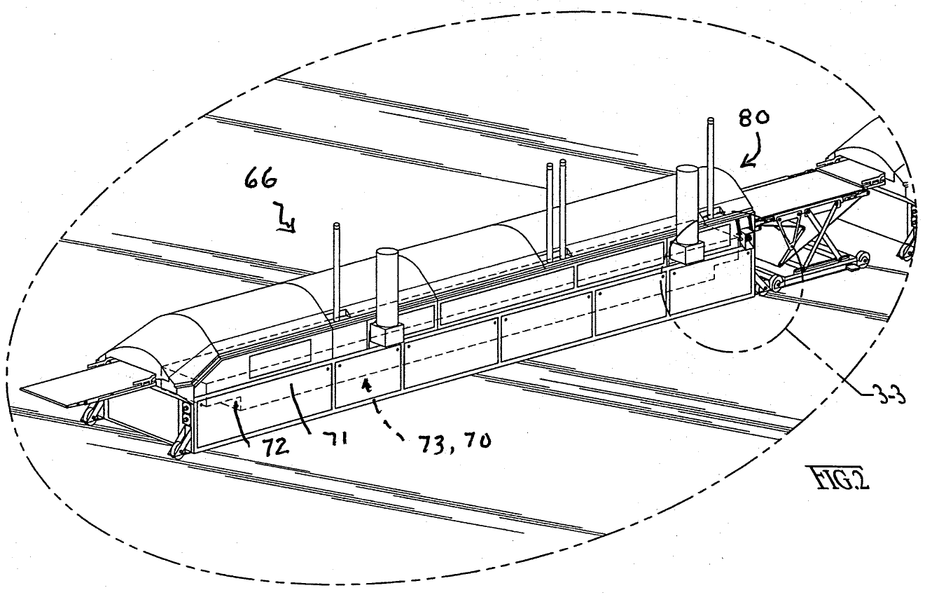

FIG. 2 shows an automatic and/or mechanized fryer 66 for automatic and/or mechanized food-process lines 50. Food-product pieces flow through this line 50 of machines from right to left, ie., from an infeed end to a discharge end. Typical food-product pieces could be chicken tenders that are going to be pre-dusted, coated in wet-batter, coated again in a dry-mix of bread crumb or the like, and then conveyed through the fryer 66, which trip through the fryer 66 either partially or fully cooks the food-product pieces, but at least sets the coatings.

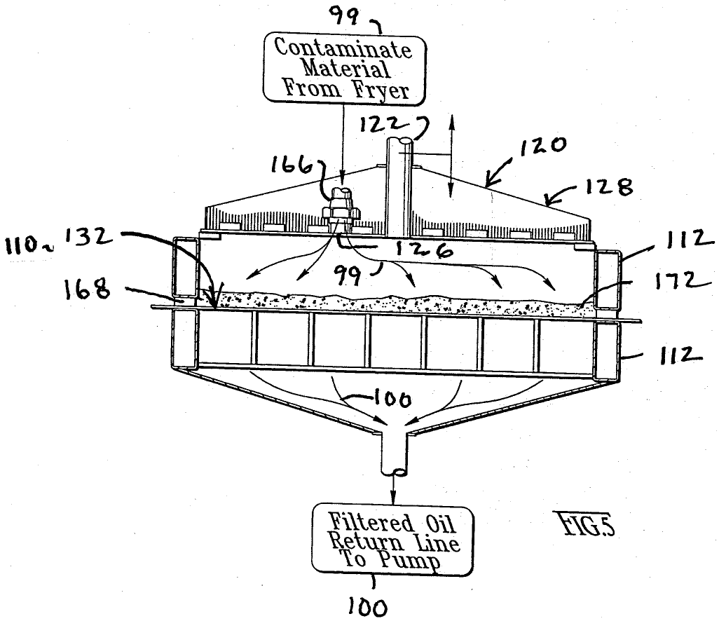

The fryer 66 has a tank bottom wall 70, tank sidewalls 71, and tank end walls 72 defining a tank 73 that would be filled (ie., to some fill level) with a bath of fry oil (eg., see FIG. 5, showing contaminated fry oil 99 and filtered oil 100). The fryer 66 has a main food-product carrying conveyor that is an endless wire mesh belt. This endless wire mesh belt has an upper food-product carrying run extending between an infeed end and discharge end. This endless wire mesh belt further has a lower return run that can be arranged to scrape along the bottom wall 70 of the fryer 66.

Suspended above the upper food-product carrying run of the main food-product carrying conveyor is a submerging conveyor which, when the food-process line 50 is running, both the main carrying conveyor and the overhead submerging conveyor are lowered into the fry oil bath. See, eg., U.S. Pat. No. 6,305,274—Nothum et al., entitled “Fryer for Food Process Lines,” referenced, and incorporated herein, above.

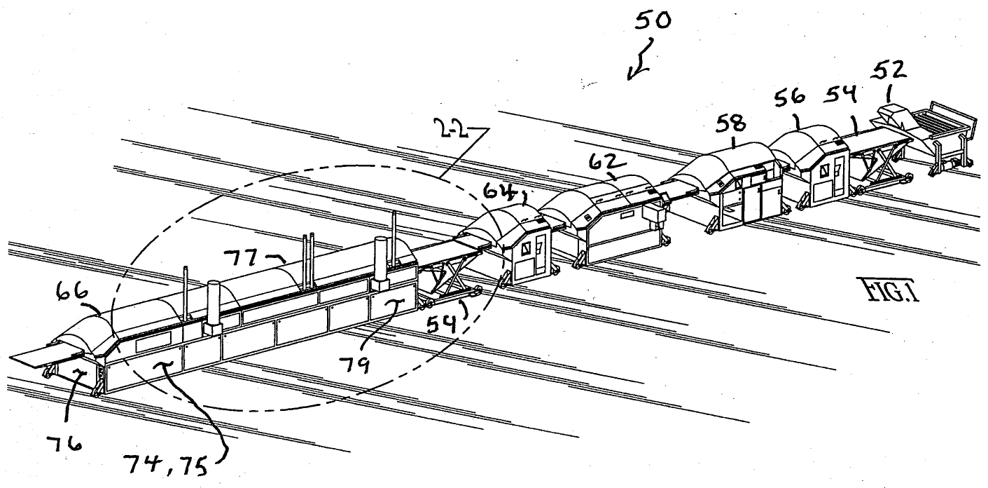

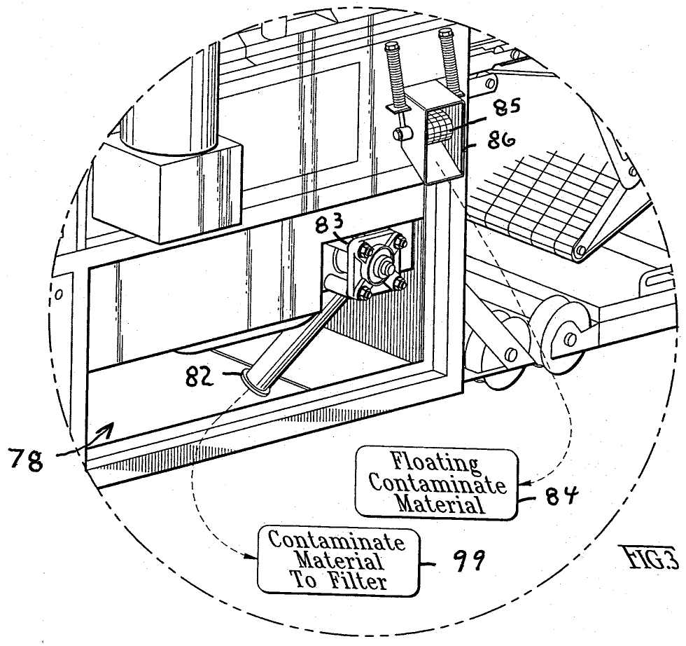

The fryer 66 further has a cabinet 74 of sidewalls 75 and end walls 76, as well as a cover 77 for covering the fry oil bath. FIG. 3 is an enlarged-scale perspective view of an opening 78 in the cabinet 74 where a panel 79 (eg., see FIG. 1) has been removed on the left sidewall 75 of the cabinet 74 below the infeed opening 80 for the fryer 66 for the infeed of food-product pieces onto the infeed end of the main food-product carrying conveyor.

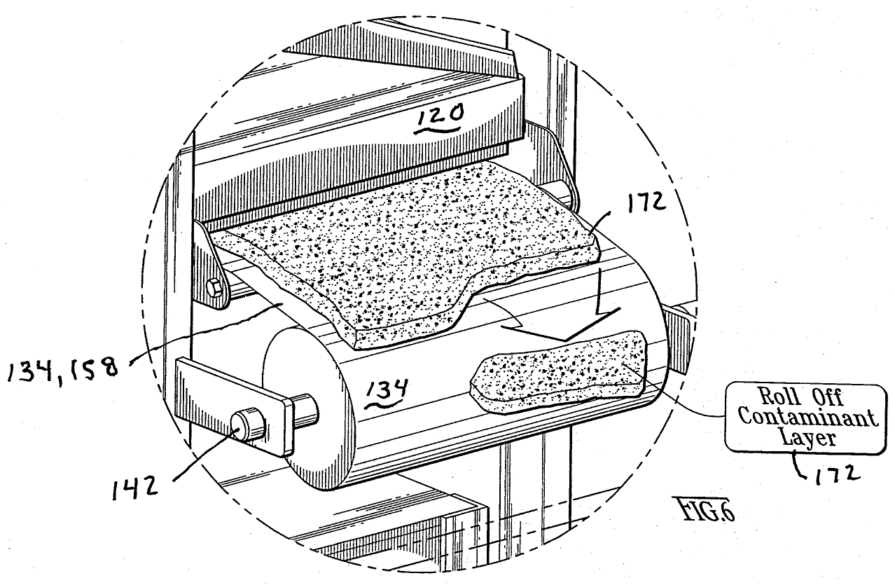

FIG. 3 shows a fry oil drain outlet 82 which is immediately below and left of the infeed opening 80 (see FIG. 2). Again, the endless, main food-product carrying conveyor has an upper food-product carrying run and a lower return run that scrapes the bottom wall 70 of the tank 73 containing the fry oil bath. Thus this lower return run motivates sinking loose crumb material (eg., dried into a cracker-like crumb cake form 172 in FIG. 6) back to the infeed end of the fry oil bath of the tank 73. The pump 83 and bottom drain 82 in FIG. 3 draw out contaminated fry oil 99 (see FIG. 5) and as laden with entrained contaminate material 172 (again, FIG. 5).

FIG. 3 is an enlarged-scale perspective view of the left side of the cabinet 74 of the fryer 66 and immediately below and to the left of the infeed opening 80 indicated in FIG. 2. Some of the contaminate material 84 floats, and thus won't be drawn through the bottom drain 82 in FIG. 3. Hence there is a cross-wise conveyor belt 85 and side outlet discharge 86 for skimming off floating contaminate material 84 and simply discharging it for disposal.

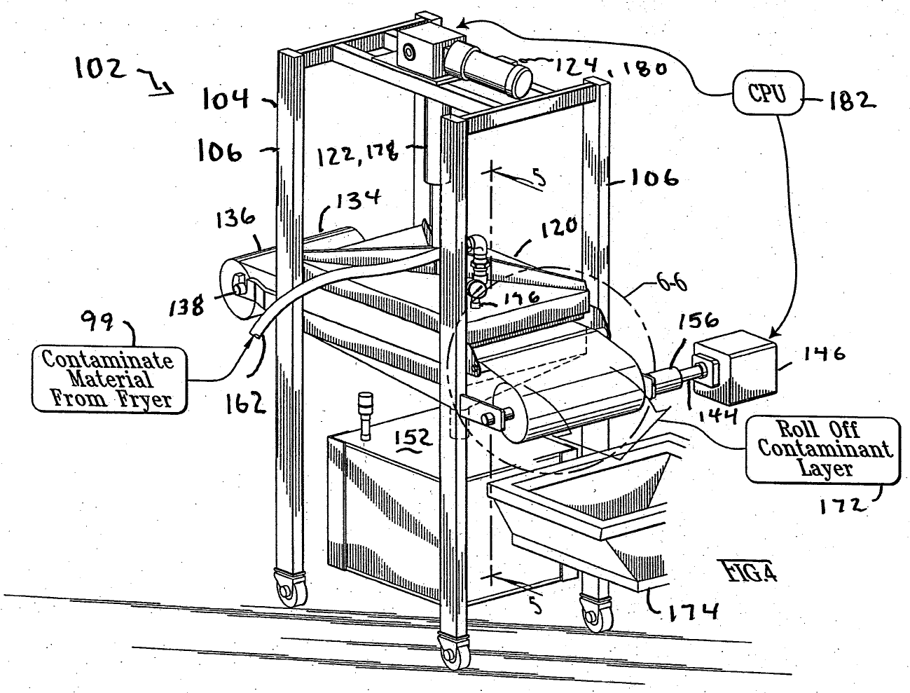

The pump 83 shown in FIG. 3 pumps out contaminated fry oil 99 from the bottom of the bath (within the tank 73) under the infeed opening 80 of the fryer 66 to a filtration/filter machine 102 in accordance with the invention as shown in FIG. 4.

To turn to FIG. 4, the filter machine 102 has a four post box frame 104 on the order of ten feet (˜3 m) tall and four feet (˜1 m) square. The frame 104 is made of four posts 106 to six inch (˜10 to ˜15 cm) thick-walled steel tube. In the center of this view, there is a thick gauge steel table top 110 propped up by one of a pair of horizontal frames 112 stacked on top of another, constructed of thick-walled steel tube. These stacked frames 112 are each about four feet (˜1 m) square and six inches (˜15 cm) tall. Above the table top 110, there is a box-like low profile hood 120 that is about four feet (˜1 m) square and six inches (˜15 cm) tall, likewise constructed thick-walled steel tube.

There is a reason for this heavy duty construction. This hood 120 is driven between upward retraction strokes and downward extension stroke to stamp into the table top 110 with 8,000 pounds (four tons) of down force into the SHUT state. The extension and retraction stokes between SHUT and LIFTED extremes are driven by an Acme screw 122 drive 124 that is centered in the upper third of this view.

Contaminated fry oil 99 flows into the SHUT hood 120 from a port 126 in the top wall 128 of the hood 120. The table top 110 has a working area 132 that is about three feet (˜0.9 m) square, which is apertured to allow outlet of filtered fry oil 100. The hood 120 in the SHUT state surrounds the perimeter of the working area 132, thus shutting the working area 132 inside under the hood 120.

Continuing in FIG. 4, it is an aspect of the invention to provide a nearly endless belt of filter membrane 134 (filter media) that transits across the working area 132 of the table top 110 (when the hood 120 is LIFTED) from left to right in this view. In actuality, this nearly endless belt of filter membrane 134 is supplied on a large supply roll 136 (as rolling on a spindle 138) which is seen to the left in the middle of this view and is about twelve inches (˜0.3 m) in diameter. On the other side of this filter machine 102 is the take up roller 142 (mounted on a drive spindle 146), which reels the filter membrane 134 across the working area 132 of the table top 110 (again, only possible when the hood 120 is in a LIFTED state).

A filtered-oil collection vat 152 is shown centered underneath the table top 110 and straddled by the four posts 106. An oil pump and a drive motor for it (neither shown) circulate the filtered oil 100 back to the fryer 66.

FIG. 6 shows the contaminated filter membrane 134 wound up on the take up roller 142. The take up roller 142 is driven by the motor 146 shown in FIG. 4. The enlarged collar 156 on the drive shaft comprises a sliding uncoupler/coupler to detach and lift the take up roller 142 from its opposite brackets which simply support the take up roller 142 like a rotisserie spit.

In general, the oil filter machine 102 operates between two states, a RUN state and a ROLL OFF (scroll) state.

In the RUN state as shown in FIGS. 4 and 5, the hood 120 is SHUT tight. Contaminated fry oil 99 is introduced into the chamber formed by the SHUT hood 120 and table top 110 until the pressure reaches operation pressure of about ten psi (two-thirds an atmosphere). That pressure is sufficient to drive the fry oil 99/100 through the filter membrane 134, and through the perforated table top 110. The filtered oil 99 is eventually collected in the collection vat 152 and returned to the fryer 66.

After a period of time (eg., twenty-five minutes), the filter membrane 134 within the outline of the working area 132 of the table top 110 (that outline on the filter membrane 134 being a ‘window 158’) becomes ‘over’ loaded with contaminant material 172, and then it becomes time to replace that ‘window 158’ with a reeled in new window 158 of fresh filter membrane 134 from the supply roll 136.

Thus, this is the ROLL OFF state, as shown by FIG. 6. The Acme-thread linear actuator 122 retracts the hood 120 up to a LIFTED state. The take up roller 142 reels the contaminated window 158 of filter membrane 134 off and across the working area 132 and indeed reels up the contaminated window 158 onto itself, ie., the take up roller 142. This likewise drags a fresh window 158 of filter membrane 134 across the table top 110 and disposed over the working area 132. The hood 120 is then driven SHUT, and things are readied for a succeeding RUN state.

However, during the ROLL OFF state, which can take as long as five minutes or so (the high pressure Acme-thread linear actuator 122 is slow). The pipe network that couples the oil pump 83 shown in FIG. 3 for pumping contaminated fry oil 99 out the drain 82 to the filtration machine 102 will be switched over by a valve to circulate the contaminated fry oil 99 in a bypass loop.

FIG. 2 shows, at the top of the four post frame 104 of the filter machine, the electric drive motor 124 for driving the Acme-thread linear actuator 122. The flexible infeed hose 162 for contaminated fry oil 99 is in the foreground, as well as the fitting 166 to the inlet port 126 in the top wall 128 of the hood 120.

FIG. 5 is a section view through the hood 120 and table top 110 showing that in the SHUT state, the two compress a polymeric box seal 168 for the hood 120. The polymeric box seal 168 is carried in a square circuit of an O-ring groove in the hood 120 that is about thirty-three inches (0.84 m) on a side. The square circuit of the O-ring groove has rounded corners so as not to stress the polymeric box seal 168. Thus the polymeric box seal 168 has a circumference of about one-hundred thirty two inches (˜3.35 m). Thus with eight-thousand pounds of force compressing the polymeric box seal 168 onto the table top 110, the polymeric box seal 168 is enduring about sixty pounds of pressure per linear inch (˜four atmospheres per linear inch). This degree of compression is sufficient to prevent oil 99/100 under ten psi of pressure inside the SHUT hood 120 from leaking out.

FIG. 6 shows a stage of progress in about the middle of the ROLL OFF state. At a time before FIG. 6 (eg., FIGS. 4 and/or 5), the hood 120 is forcibly driven down tightly in the SHUT state. There is a period of time wherein the hood 120 is pressurized with bottled air or an inert gas to drive out the remnants of filtered fry oil 100 in the hood 120's chamber, and, dry the contaminant layer 172 into a cake-like material.

Wherein, while this material 172 to-be-filtered has been often referred to as contaminant material 172 herein, it truthfully will dry into a cake-like material 172 that is suitable for feeding to livestock. It is not harmful contaminant material 172 to people or the environment. It is only harmful to good fry oil 100 and to infusing bitter/distasteful flavors to good fry oil 100, ie., degrading good fry oil 100. Such contaminant material 172 still has a nutrition value that is worthy of feeding to livestock.

FIG. 6 shows the hood 120 in a LIFTED state, and the take up roller 142 rolling and reeling in the filter membrane 134. FIG. 6 further shows the square window of collected contaminant material 172, eg., crumb cake, being conveyed on top of the filter membrane 134 and transiting across and over the top of the take up roller 142. The square window of crumb cake 172 transits so far over the take up roller 142 that the square window of crumb cake 172 is cantilevered in air such that is cracking off, at first in an even slice 172. That slice 172 will tumble and crack into cracker like pieces. The crumb cake 172 progressively cracks off in slices 172 or, at the initiation of cracking, in cracks and tumbles off in cracker-like pieces of the crumb cake 172.

Eventually, all of the crumb cake 172 will crack off and be ejected into a crumb collection tote 174 (see FIG. 4). The filter membrane 134 being spooled off the supply roll 136 will likewise ‘eventually’ provide a fresh new window 158 of filter membrane 134 over the working area 132 of the table top 110. Again, the crumb cake 172 collected in the collection tote 174 is satisfactory for livestock feed.

The following relates to other matters, principally safety and fail-safe measures.
1. PSI air safety (eg., pop off 176 among other measures).
2. Load cell 178 pressure safety.
3. Encoder 180 safety.
4. Round radius on O-ring groove and box seal 168 for better safer seal.
5. Two stage oil safety containment.
6. Low pressure (˜10 psi) hood 120 compartment operating pressure.
7. Acme driver lift 122 and 124.
8. Hood 120 compartment (inbox) safety pop off 176 is fifteen (15) PSI.
9. Any oil leakage will be caught in crumb cake 172.

In what follows, several of the items above will be re-visited to explain further.

Items 1, 2, 6 and 8 are related in that the aims of the safety measures are about the same. The oil filtration box (hood 120) is a low air pressure and low fluid pressure system designed to operate at below 15 psi (1 atm) to move and filter fry oil 99/100 through the filtration media (filter membrane 134) and remain below 15 psi (1 atm) during the crumb 172 drying process. So while these things are similar to each other, one might be more concerned with hot oil pressure while and the other or others is/are more concerned with air pressure.

Items 2, 3 and 4 relate to a load cell 178 that is actually monitoring and maintaining the 8,000 pounds (four tons) of down force between the hood 120 and table top 110, compressing a polymeric gasket/box seal 168. The polymeric box seal 168 is carried in a square circuit of an O-ring groove in the hood 120 that is about thirty-three inches (0.84 m) on a side. The O-ring groove square circuit has rounded corners so as not to stress the polymeric box seal 168.

And this leads into item no. 3 above. The linear actuator 122 and/or the drive shaft of its electric drive motor 124 will be equipped with a shaft encoder 180. The shaft encoder 180 will be calibrated to discern the length of the drive stroke Acme screw linear actuator 122 so accurately, that a controller/CPU 182 will be able to determine if the box seal 168 is fit for duty, or has reached a state where it is best to replace the current seal 168 with a fresh seal 168. That is, encoder 180 will monitor the distance it takes to get the load cell 178 to read the 8,000 pounds (four tons) of down force. At a certain point, the encoder 180 will travel too far, indicating the seal 168 is at a failure state thus prompting the user to replace the seal/gasket 168.

Items 5 and 9 pertains to that fraction of contaminated fry oil 99 that does not pass through the perforated table top 110 (and thus does not get returned to the fryer 66's fry oil bath). That fraction of contaminated fry oil 99 is either caught in the crumb cake 172 and will be ejected with the crumb cake 172 into the crumb tote 174, otherwise any other contaminated fry oil 99 leakage is caught by a gutter system and also delivered to the crumb tote 174.

Item no. 7 relates to a sensor that reads hood 120 position, either the encoder 180 mentioned in connection with item no. 3 above, or an additional sensor, which provides a reading indicating hood 120 position. The CPU 182 monitors that sensor's signal and correlates hood 120 position for, among other reasons, determining when the hood box 120 is in the ‘target’ furthest up position. The ‘target’ furthest up position triggers the CPU 182 to stop the drive motor 124 of the Acme thread linear actuator 122, to avoid over traveling, and zero out the encoder 180 (or other sensor).

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

1. A method of fry oil filtration for an automated and/or mechanized fryer for automated and/or mechanized food-process lines; comprising the steps of:
providing a perforated table top;
covering the perforated table top with filtration media;
lowering a hood from a LIFTED state onto the filtration media and table top for forming a SHUT tight state to form a pressure-tight compartment;
pumping hot fry oil from a fry oil bath of an automated and/or mechanized fryer in the automated and/or mechanized food process line, which hot fry oil carries a fraction of crumb contaminant material, into the pressure-tight compartment;
collecting the hot fry oil that passes through the filtration media and perforated table top for return to the fry oil bath of the fryer;
after so long of a RUN time, discontinue pumping hot fry oil from the fry oil bath of the fryer;
raise the hood to a LIFTED state;
move the filtration media, with a cake of crumb contaminate material caked thereon, off the table top;
provide fresh filtration media; and
return to the step of covering the perforated table top with filtration media.

2. The method of claim 1, further comprising the steps of:
providing the filtration media in a bulk roll mounted on a roller on one side of the table top;
coursing the filtration media in a ribbon across the table top to a driven take up roller on the other side of the table top;
wherein the step of moving the filtration media, with a cake of crumb contaminate material caked thereon, off the table top comprises reeling the filter media onto the take up roller concurrently with (1) allowing the cake of crumb contaminate material to crack up/fall away as well as (2) allowing provision from the bulk roll of fresh filtration media covering the table top.

3. The method of claim 2, further comprising the step of:
catching the falling away/cracked up crumb contaminate material in a crumb cake collection tote.

4. The method of claim 1, further comprising:
between the steps of discontinuing pumping and raising the hood, the further step of:
purging the compartment with pressurized air or an inert gas to dry the crumb cake.

5. A method of fry oil filtration for an automated and/or mechanized fryer for automated and/or mechanized food-process lines; comprising the steps of:
providing a perforated table top;
providing a hood in a LIFTED state above the perforated table top;
covering the perforated table top with filtration media;
lowering a hood from the LIFTED state onto the filtration media and table top for forming a SHUT tight state to form a pressure-tight compartment;
pumping hot fry oil from a fry oil bath of an automated and/or mechanized fryer in the automated and/or mechanized food process line, which hot fry oil carries a fraction of crumb contaminant material, into the pressure-tight compartment;
pumping the hot fry oil at a pressure pressurizing the compartment; and
collecting the hot fry oil that passes through the filtration media and perforated table top for return to the fry oil bath of the fryer.

6. The method of claim 5, further comprising the steps of:
after so long of a RUN time, discontinue pumping hot fry oil from the fry oil bath of the fryer;
raise the hood to a LIFTED state;
move the filtration media, with a cake of crumb contaminate material caked thereon, off the table top;
provide fresh filtration media;
return to the step of covering the perforated table top with filtration media;
providing the filtration media in a bulk roll mounted on a roller on one side of the table top;
coursing the filtration media in a ribbon across the table top to a driven take up roller on the other side of the table top;
wherein the step of moving the filtration media, with a cake of crumb contaminate material caked thereon, off the table top comprises reeling the filter media onto the take up roller concurrently with (1) allowing the cake of crumb contaminate material to crack up/fall away as well as (2) allowing provision from the bulk roll of fresh filtration media covering the table top.

7. The method of claim 6, further comprising the step of:
catching the falling away/cracked up crumb contaminate material in a crumb cake collection tote.

8. The method of claim 6, further comprising:
between the steps of discontinuing pumping and raising the hood, the further step of:
purging the compartment with pressurized air or an inert gas to dry the crumb cake.

9. The method of claim 5, wherein:
the step of pumping hot fry oil from a fry oil bath of an automated and/or mechanized fryer further comprises the steps of:
providing the fryer with an elongate fry-oil bath contained by a fry-oil-bath bottom wall joined with spaced fry-oil-bath sidewalls and spaced fry-oil-bath end walls;
the fryer having an endless conveyor submerged inside the fry-oil bath;
the endless conveyor having a food product carrying run running from a food product infeed end of the fryer and fry-oil bath to a discharge end for the fryer and fry-oil bath, as well as a return run running from the discharge end, under the food product carrying run along the fry-oil bath bottom wall, to the infeed end;
the return run motivating crumb contaminate material toward a drain; and
pumping hot fry oil from the drain.

10. A method of fry oil filtration for an automated and/or mechanized fryer for automated and/or mechanized food-process lines;
comprising the steps of:
providing a perforated table top;
providing a hood in a LIFTED state above the perforated table top;
providing elongate filtration media on a supply roll;
covering the perforated table top with a portion of the filtration media unrolled off the supply roll but remaining attached as a ribbon;
lowering a hood from the LIFTED state onto the filtration media and table top for forming a SHUT tight state to form a pressure-tight compartment;
pumping hot fry oil from a fry oil bath of an automated and/or mechanized fryer in the automated and/or mechanized food process line, which hot fry oil carries a fraction of crumb contaminant material, into the pressure-tight compartment;
pumping the hot fry oil at a pressure pressurizing the compartment; and
collecting the hot fry oil that passes through the filtration media and perforated table top for return to the fry oil bath of the fryer.

11. The method of claim 10, further comprising the steps of:
after so long of a RUN time, discontinue pumping hot fry oil from the fry oil bath of the fryer;
raise the hood to a LIFTED state;
move the filtration media, with a cake of crumb contaminate material caked thereon, off the table top;
return to the step of covering the perforated table top with a fresh portion of the filtration media unrolled off the supply roll but remaining attached as a ribbon.

12. The method of claim 11, further comprising the steps of:
providing the filtration media in a bulk roll mounted on a roller on one side of the table top;
coursing the filtration media in a ribbon across the table top to a driven take up roller on the other side of the table top;
wherein the step of moving the filtration media, with a cake of crumb contaminate material caked thereon, off the table top comprises reeling the filter media onto the take up roller concurrently with (1) allowing the cake of crumb contaminate material to crack up/fall away as well as (2) allowing provision from the bulk roll of fresh filtration media covering the table top.

13. The method of claim 12, further comprising the step of:
catching the falling away/cracked up crumb contaminate material in a crumb cake collection tote.

14. The method of claim 11, further comprising:
between the steps of discontinuing pumping and raising the hood, the further step of:
purging the compartment with pressurized air or an inert gas to dry the crumb cake.

15. The method of claim 10, wherein:
the step of pumping hot fry oil from a fry oil bath of an automated and/or mechanized fryer further comprises the steps of:
providing the fryer with an elongate fry-oil bath contained by a fry-oil-bath bottom wall joined with spaced fry-oil-bath sidewalls and spaced fry-oil-bath end walls;
the fryer having an endless conveyor submerged inside the fry-oil bath;
the endless conveyor having a food product carrying run running from a food product infeed end of the fryer and fry-oil bath to a discharge end for the fryer and fry-oil bath, as well as a return run running from the discharge end, under the food product carrying run along the fry-oil bath bottom wall, to the infeed end;
the return run motivating crumb contaminate material toward a drain; and
pumping hot fry oil from the drain.
